(19) United States
(12) Patent Application Publication
(10) Pub. No.: US 2017/0118260 A1
(43) Pub. Date: Apr. 27, 2017

(54) METHOD FOR PROMOTING A MERCHANT ADVERTISEMENT

(71) Applicant: LIFE IMPACT SOLUTIONS, Irvine, CA (US)

(72) Inventor: Aaron Horvath, Ladera Ranch, CA (US)

(21) Appl. No.: 15/399,541

(22) Filed: Jan. 5, 2017

Related U.S. Application Data
(63) Continuation of application No. 14/183,397, filed on Feb. 18, 2014.
(60) Provisional application No. 61/766,343, filed on Feb. 19, 2013.

(51) Int. Cl. H04L 29/06; H04L 29/08

(52) U.S. Cl. CPC H04L 65/403; H04L 67/18; H04L 67/34

(57) ABSTRACT

A method for obtaining decision advice from a set of confidants comprises the steps of receiving a plurality of user inputs on a source communication device from a user to generate a pending decision, receiving at least one user input on the source communication device to select one or more confidants from the set of confidants, posting the user inputs to an application server that is being coupled with an application of the source communication device via at least one network, sending the user inputs to other communication devices associated with the one or more confidants, receiving a set of selections from at least one confidant and posting a message that indicates the user has made a decision. The user inputs are defined as a set of choices including at least one of a set of images and a set of text characters.

### CROSS-REFERENCE TO RELATED APPLICATIONS

This application is a continuation of U.S. Utility patent application Ser. No. 14/183397, filed on Feb. 18, 2014, which claims priority to U.S. Provisional Patent Application No. 61/766,343, filed on Feb. 19, 2013.

### BACKGROUND OF THE DISCLOSURE

Technical Field of the Disclosure

The present embodiment relates in general to decision making methods. More specifically, the present disclosure relates to method for quickly obtaining decision advice from a set of confidants.

Description of the Related Art

Every day people need to make many decisions about many different things. For example, a person needs to decide what to get for a child's birthday party. Typically, a wide range of possibilities are available from which the person (hereafter referred to as the “decision maker”) may decide on one particular possibility. For example, the decision maker may need to choose a particular birthday cake from several birthday cakes offered for sale at a bakery. There are many ways people make such decisions. Some examples of how people decide include researching in advance of making the decision, performing a mental cost-benefit analysis before making the decision, or simply relying on a gut instinct. For several reasons, however, these techniques are often inadequate when it comes time to actually making the decision. For example, a person may not feel comfortable making a decision to buy one type of car over another type of car, even if the person has researched the cars in advance. In short, a decision person's ability to decide often depends on a certain amount of specialized knowledge, the context in which the decision is to be made, and/or the person's own temperament with respect to making the decision.

In order to feel more comfortable in making such decisions, therefore, a decision maker may seek advice from another person (hereafter referred to as a “confidant”), such as a friend, a family member, or a peer. For a variety of reasons, however, seeking advice from a confidant is not always feasible. For instance, sometimes the confidant is not with the decision maker at the time when the decision is to be made. While the decision maker may be able to call the confidant for advice, sometimes it is difficult to reach the confidant (e.g., cannot recall the confidant's phone number or can only reach the confidant's voice mail). In other cases, the decision maker seeks the advice of several different confidants, some or all of whom are not available. Some decision makers have relied on email messages to all of the different confidants when the decision is pending. However, this is problematic for a decision maker who is seeking to make a decision quickly, because responses to the email may be delayed (e.g., one or more confidants do not check email regularly) and/or scattered (e.g., some confidants reply to the email message immediately, some other confidants reply to the email later, while still other confidants try to call the decision maker or decide to wait until the next time the confidant sees the decision maker).

Soliciting decision advice has been a way in which many people make decisions. Even people who have already made a decision in their own mind sometimes wish to obtain decision advice from others to see how their decision stacks up against the decisions other people make. For example, a person may not feel confident in accurately gauging whether a particular item of apparel looks better in blue or in green when it is worn with another apparel item of the person. Thus, decision advice is beneficial for many people who need to make a decision (e.g., a person needs advice at the time of buying an item). However, to obtain such advice, many people need to call or text another person in order to give the confidant a list of choices on which the advice is sought. This is slow and scattered because the person cannot simultaneously call and text everyone. Even using email (which allows an email blast to be sent to several confidants at the same time) is not sufficient because the responses are often delayed.

Therefore, there is a need for a method to quickly obtain a decision advice from a set of confidants. Such a method simplifies the decision making process and thereby making the process accessible to non-technical users through an enhanced, user-friendly experience. Such a method would allow a user to post a set of choices regarding a pending decision. Such a method would allow a user to select one or more confidants from the set of confidants. Such a method would allow the one or more confidants to provide a set of selection in response to the set of choices posted by the user. Such a needed method would allow the set of confidants to choose a particular choice from the set of choices via a set of votes and/or a set of comments. This method would allow the user to post message that indicates the user has made a decision. Such a method would allow the set of confidants to provide a feedback related to the message that indicates the user has made a decision. Further, this method would provide the benefit of obtaining advice by posting the set of choices to the set of confidants so that the user reaches a wider range of confidants and may receive immediate feedback from most or all of the confidants with respect to the pending decision. Finally, such a method would be implemented as an application that executes on one or more processors of a plurality of communication devices.

### SUMMARY OF THE DISCLOSURE

To minimize the limitations found in the prior art, and to minimize other limitations that will be apparent upon the reading of the specifications, preferred embodiment of the present invention provides a method of obtaining decision advice from a set of confidants.

The method is implemented as an application that executes on one or more processors of a plurality of communication devices. Initially, a source communication device receives a plurality of user inputs from a user to generate a pending decision. The plurality of user inputs is defined as a set of choices. The source communication device receives at least one user input to select one or more confidants from the set of confidants. The set of choices is posted to an application server that is being coupled with an application of the source communication device via at least one network. The set of choices is sent to other communication devices associated with the one or more confidants. The decision advice is received from at least one confidant among the one or more confidants. The decision advice is received after the at least one confidant selects a particular choice from the set of choices. Finally, a message that indicates the user has made a decision is posted. The plurality of user inputs is defined as a set of choices. The set of choices include at least one of a set of images and a set of text characters. In some embodiments, the set of selections comprise a set of votes associated with the set of choices. In some embodiments, the set of selections comprise a set of comments associated with the set of choices. The set of selections in some embodiments is received contemporaneously with when the set of choices is posted.

In some embodiments, a computer program product comprising a computer readable storage medium having a computer readable program is provided. The computer readable program when executed on a computer causes the computer to perform the functions and operations associated with the above-disclosed methods.

In some embodiments, a system for obtaining decision advice from a set of confidants is provided. The system comprises a plurality of communication devices capable of running an application. The application is configured to receive a plurality of user inputs on source communication device to generate a pending decision and receive at least one user input on the source communication device to select one or more confidants from the set of confidants. The plurality of user inputs is defined as a set of choices. The system further comprises an application server that is coupled to the plurality of communication devices via at least one network. The application server is configured to receive the set of choices and send the set of choices to other communication devices associated with the one or more confidants and receive the decision advice from at least one confidant among the one or more confidants. The decision advice is received after the at least one confidant selects a particular choice from the set of choices.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a flow chart of a method of obtaining decision advice from a set of confidants in accordance with the preferred embodiment of the present invention;

FIG. 2 is a flow diagram illustrating an example process flow of a step of posting a set of choices in one embodiment; and

FIG. 3 is a use case diagram depicting ways in which a user may interact with a system for obtaining decision advice from the set of confidants in accordance with an exemplary embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

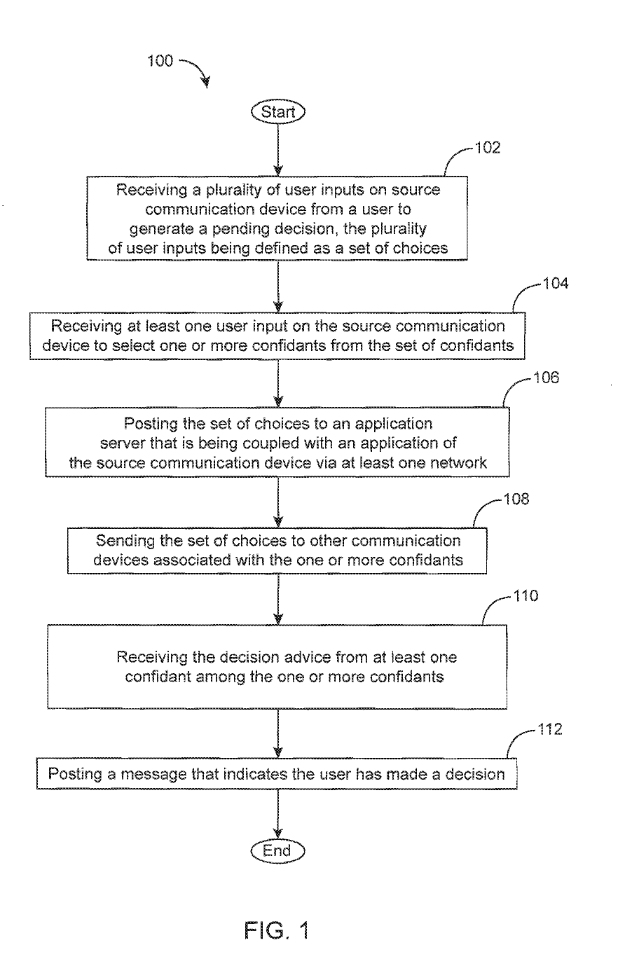

Turning first to FIG. 1, a flow chart of a method 100 of obtaining decision advice from a set of confidants in accordance with the preferred embodiment of the present invention. The method is implemented as an application that executes on one or more processors of a plurality of communication devices. Initially, a source communication device receives a plurality of user inputs from a user to generate a pending decision as indicated at block 102. The plurality of user inputs is defined as a set of choices. The source communication device receives at least one user input to select one or more confidants from the set of confidants as indicated at block 104. The set of choices is posted to an application server that is being coupled with an application of the source communication device via at least one network as indicated at block 106. The set of choices is sent to other communication devices associated with the one or more confidants as indicated at block 108. The decision advice is received from at least one confidant among the one or more confidants as indicated at block 110. The decision advice is received after the at least one confidant selects a particular choice from the set of choices. Finally, a message that indicates the user has made a decision is posted as indicated at block 112. The plurality of user inputs is defined as a set of choices. The set of choices include at least one of a set of images and a set of text characters. In some embodiments, the set of selections comprise a set of votes associated with the set of choices. In some embodiments, the set of selections comprise a set of comments associated with the set of choices. The set of selections in some embodiments is received contemporaneously with when the set of choices is posted.

For instance, the user requires a decision to purchase a new mobile device. The user posts decision criteria and visual content on a source communication device hosted with an application. An application server receives decision criteria and visual content via at least one network. The application server send request to user's friends for immediate feedback. The friends provide an opinion on decision via their votes and/or comments. The application server consolidates the advice for the user and the user makes final decision using the set of votes and/or the set of comments received from the one or more confidants. The decision is finalized on the application.

In one embodiment, the method includes the steps of posting a message that indicates the user has made a decision and receiving a feedback related to the massage that indicates the user has made a decision from the one or more confidants. In one embodiment, the at least one network is a data communication network. The data communication network is selected from a group consisting of: Internet, a local area network (LAN), a wide area network (WAN), wired Ethernet, wireless Ethernet, cellular wireless network and any other network capable of transmitting information. The source communication device and other communication devices are selected from a group consisting of: a cellular telephone, a smartphone, a wireless-enabled personal digital assistant, a tablet, a personal computer, a note book, a mobile device and any other device that receives and transmits data from at least one network.

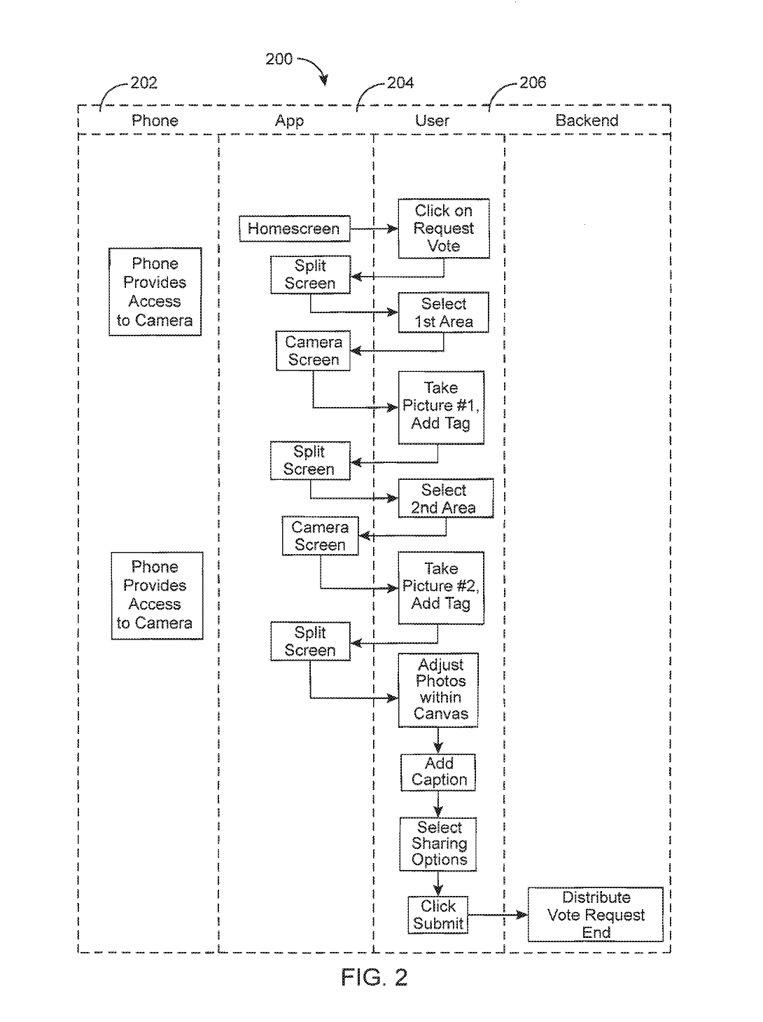

FIG. 2 is a flow diagram illustrating an example process flow of a step of posting a set of choices in one embodiment. The flow diagram 200 describes the benefit of obtaining advice using the method 100 to post choices to the set of confidants is that the user can reach a wider range of confidants and may receive immediate feedback from most or all of the confidants with respect to the pending decision. Thus, by using a mobile device 202 providing access to a camera, for example, a user 206 seeking advice on purchasing different pairs of shoes. The user can quickly take pictures of the shoes and post the pictures in canvas and other relevant textual information with captions related to the shoes to the set of confidants via an application 204 in order to solicit immediate feedback from the set of confidants about which pair to buy.

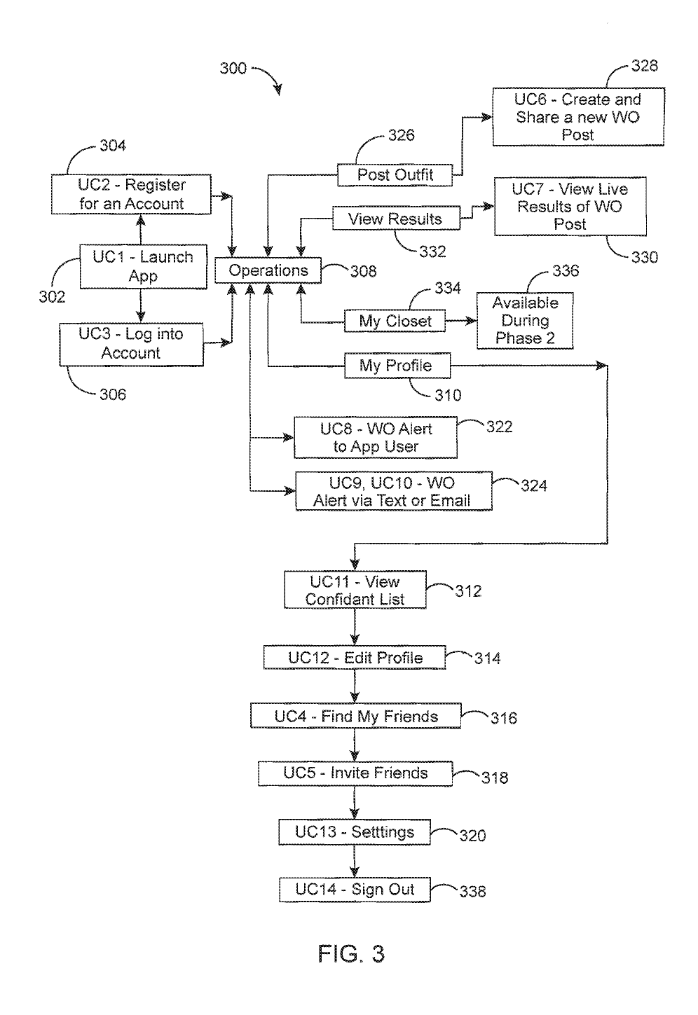

FIG. 3 is a use case diagram depicting ways in which the user may interact with a system for obtaining decision advice from the set of confidants in accordance with an exemplary embodiment of the present invention. The use cases diagram 300 UC1-UC14 depicted in FIG. 3 illustrate various scenarios that may be encountered by the system. The system comprises a plurality of communication devices capable of running an application. The application is configured to receive a plurality of user inputs on source communication device to generate a pending decision and receive at least one user input on the source communication device to select one or more confidants from the set of confidants. The plurality of user inputs is defined as a set of choices. The system further comprises an application server that is coupled to the plurality of communication devices via at least one network. The application server is configured to receive the set of choices and send the set of choices to other communication devices associated with the one or more confidants and receive the decision advice from at least one confidant among the one or more confidants. The decision advice is received after the at least one confidant selects a particular choice from the set of choices.

In some embodiments, the user may use an “application” loaded into a web browser to access a website (UC1) as indicated at block 302. The application may allow the user to register to the website for an account (UC2) as indicated at block 304 or login to the website (UC3) as indicted at block 306. The launched application may allow the user to access operations on the website as indicated at block 308. The application may further allow the user to visit profile at block 310, access a list of confidants (UC11) at block 312, edit profile (UC12) at block 314, find friends (UC4) at block 316, invite friends (UC5) at block 318, set up profile settings (UC13) as indicated at block 320. The application may further allow the user to create user events and invitations, access a message center, and access a list of purchased or available products. The user may enter user credentials, such as a login name and/or a password, in order to gain access to part or all of the features available via the website. In one exemplary embodiment, the website may share resources, services, content, media, code, images, audio, video or other similar media or data. The website may be hosted on the application server, accessible via at least one network using a URL. UC8-UC10 corresponds to provide work order (WO) alert and WO alert via text or email as indicated at blocks 322 and 324. The application may allow user to post outfit as shown at block 326 and create and share a new WO post (UC6) as indicated at block 328. The application may allow user to view live WO post (UC7) at block 330 and view results at block 332. The application may further allow the user to view closet which was initially made available in Phase II as indicated at blocks 334 and 336 respectively.

As indicated at block 338, once the user has finished the desired interaction with the application currently displayed on the mobile device, the user may exit/sign out or logoff the application (UC14) on the mobile device to quit the session or return to the application to obtain a decision on a new case.

While the embodiments described above indicate that the user has a mobile device (e.g., a smart phone), it is noted that the set of confidants each also must have some kind of communication device (e.g., a laptop, a desktop computer, a smart phone, etc.). In these embodiments, the user and each confidant must download and install the application in which the method is implemented. By way of example, the application may be loaded into the mobile device's operating system or platform. In some embodiments, the application may be downloaded for a widely available mobile platform such as iPhone, Android, Windows Phone 7, or Blackberry. In this way, the user can create a pending decision. In some cases, the user can create several predefined pending decisions in advance of the time in which the user must make the decision. For instance, the user can go “window shopping” or peruse items offered for sale on the Internet, and later when actually shopping at the store, post the set of choices for any, all, or none of the predefined decisions. For example, the user may post a first set of choices related to a first predefined decision, but might not post a second set of choices related to a second predefined decision because the user did not like the appearance of the items related to the second decision when the user was shopping at the store.

In some embodiments, the application may enable the user to use features of the mobile device that may not have the ability to be implemented via the application. These features may include, for example, use of the mobile device's camera, multi-touch services, and geo-location/GPS services. In some embodiments, the method includes receiving selections of one or more confidants from a predefined group of several different confidants. The method in some of these embodiments depends on the received selections of confidants and a custom group of confidants from which immediate feedback on a pending decision is requested.

Rather than arbitrarily posting decision questions to an entire set of confidants (e.g., all friends in a social network, etc.), custom grouping provides the user a level of granularity in making a decision. For example, the user may seek advice on clothes from a first group of confidants who know about fashion and style, while the same user may seek advice about a which stock to purchase from an entirely different group of confidants who are familiar with finance. This ability to refine the target group of confidants is especially important when a person needs to make a decision on a particularly technical item (e.g., “which laptop is best for my needs?” etc.)

In some embodiments, the set of selections the confidants provide to the set of choices includes a set of votes associated with the set of choices. For example, the person making a decision may “poll” the set of confidants and make a decision on the most popular choice. Alternatively, or in conjunction with such “polling”, the set of selections of some embodiments include a set of comments associated with the set of choices. For instance, in addition to “polling” and receiving “votes” related to the choices, the confidants may provide quantitative feedback (e.g., “buy at least five pair of gold-plated banana plugs”) and qualitative feedback (e.g., “get the deluxe model if you can afford it, but if not, get the base model anyway”).

In some embodiments, the method includes ending a time period in which the set of confidants can provide input about the user's pending decision. In some embodiments, the method includes posting a message that the user has made a decision and that further feedback is not needed. In some embodiments, the message is posted to the set of confidants but allows the set of confidants to add comments anyway, for instance, “I would have signed up for the 12-month price lock-in deal instead of paying every month”. In some cases, the set of confidants may provide valuable feedback that the user may consider after the purchase. For example, post-purchase comments may be reviewed by the user who subsequently decides to return the item for a refund based on the post-purchase comments.

In some embodiments, the method includes receiving GPS location information of the user, sending the GPS location information to a service that associates the user's location with any merchant the same or nearby locations, and receiving a set of merchant advertisements to display on the user's device. In some embodiments, the set of merchant advertisements displayed on the user's device include only merchant advertisements that pertain to the content of the pending decision. For example, if a user is seeking decision advice about which outfit to purchase at a retail store, the retail store may have the option to “pay to display” store location information and/or promote various other items to the user and the set of confidants. In some embodiments, the method facilitates dynamic posting of the set of choices such as branding, colors, logos, verbiage and offers based on the GPS location of the user.

In some embodiments, the application server(s) and the plurality of communication device(s) may be connected to the at least one network via an internet connection connected. In some embodiments, the connections may be via wired, wireless, or cellular technology. The wired network may be a LAN, WAN, cellular network or other network. The wireless network may be Wi-Fi, Bluetooth, or other wireless protocol. The cellular network 81 may be 3G, 4G, EDGE, or other cellular network.

An embodiment of the present invention relates to a computer storage product with a computer-readable medium having computer code thereon for performing various comput-er-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

In other words, application may be implemented as program code embedded in a computer program product in form of a machine-usable or computer readable storage medium that provides program code for use by, or in connection with, a machine, a computer or any instruction execution system. Moreover, application may comprise one or more computer programs that are executed on top of system software after being loaded from storage media into local memory.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, may be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that may direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowcharts and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A method of promoting a merchant advertisement, comprising:
associating a geographic location of a person with a merchant;
sending an advertisement associated with the merchant to be displayed by a mobile device carried by the person;
using a pay to display model to promote the advertisement in a post to social networking friends of the person.

2. The method of claim 1, further comprising the person downloading and installing an application in which the method is implemented.

3. The method of claim 1, wherein the post including a snapshot.

4. The method of claim 1, further comprising the post including a request for assistance in making a decision.

5. The method of claim 1, wherein the advertisement is an instance of a set of advertisements sent to the mobile device.
